(19) United States
(12) Patent Application Publication
(10) Pub. No.: US 2021/0387777 A1
(43) Pub. Date: Dec. 16, 2021

(54) COSMETIC BOTTLE

(71) Applicant: HCT GROUP HOLDINGS LIMITED, SHEUNG WAN (CN)

(72) Inventors: DENIS PIERRE MAURIN, LOS ANGELES, CA (US); THOMAS SANG CHUN, BUENA PARK, CA (US)

(73) Assignee: HCT GROUP HOLDINGS LIMITED, SHEUNG WAN (CN)

(21) Appl. No.: 17/343,396

(22) Filed: Jun. 9, 2021

Related U.S. Application Data
(60) Provisional application No. 63/037,388, filed on Jun. 10, 2020.

(51) Int. Cl. B65D 51/28; A45D 34/00; B65D 1/02; B65D 41/04; B65D 41/16

(52) U.S. Cl. CPC B65D 51/2835; A45D 34/00; B65D 1/0246; B65D 41/04; A45D 2200/056; B65D 2251/0015; B65D 2251/0059; B65D 2251/0078; B65D 41/16

(57) ABSTRACT

A cosmetic container may include a bottle having a first open end and a second open end, defining a cavity therebetween. A sealing film may be adapted for placement at the second open end of the bottle, and a cap may be configured to engage with the second open end of the bottle, such that the cap fits over the sealing film thereby covering the sealing film and closing the second open end. The first open end may be adapted for dispensing a product held within the cavity of the bottle.

### CROSS REFERENCE TO RELATED APPLICATIONS

The present application claims the benefit of and priority to U.S. Provisional Patent Application Serial No. 63/037,388, filed on Jun. 10, 2020, titled COSMETIC BOTTLE, the disclosure of which is incorporated herein by reference.

### TECHNOLOGY FIELD

The present application related generally to a cosmetic container, and in particular, to a cosmetic bottle.

### BACKGROUND

Devices exist for holding cosmetic or medicinal products. Some such devices comprise a tubular shell or botte for holding a product, and a cap for closing the tube or bottle. In the cosmetics and personal care industries, these devices are used for containing a product to be applied to a body. Exemplary products include liquids, creams, gels, and various makeup and skincare products such as foundation, concealer, lotion serum, petroleum products, moisturizer, sunscreen, etc. For such devices, the construction may include a molded structure on one end having threading and an opening for filling with a cosmetic or medicinal product, and the other end sealed. With such devices, a user may remove the cosmetic or medicinal product through the open end, however, the user may not be able to extract the entirety of the cosmetic or medicinal product. The ability to extract the entirety of the cosmetic or medicinal product may be desirable, as well as alternative aesthetics. Accordingly, there remains a need for improved cosmetic containers and alternative manufacturing processes.

### SUMMARY

This disclosure provides design, material, manufacturing methods, and use alternatives for cosmetic packaging. In particular, a refillable bottle and dispenser combination is disclosed.

In a first non-limiting example, a cosmetic container may include a bottle having a first open end and a second open end, defining a cavity therebetween. A sealing film may be adapted for placement at the second open end of the bottle, and a cap may be configured to engage with the second open end of the bottle, such that the cap fits over the sealing film thereby covering the sealing film and closing the second open end. The first open end may be adapted for dispensing a product held within the cavity of the bottle.

Alternatively, or additionally, in another example, the sealing film may be a foil film.

Alternatively, or additionally, in another example, the first open end may include a neck portion, wherein the neck portion may include one or more outer threads.

Alternatively, or additionally, in another example, a pump may be configured to engage with the one or more outer threads of the neck portion, the pump being used to dispense the product held within the cavity.

Alternatively, or additionally, in another example, the cap may engage with the second open end of the bottle via a snap-fit.

Alternatively, or additionally, in another example, the cap may engage with the second open end of the bottle via friction fit.

Alternatively, or additionally, in another example, the cap may engage with the second open end of the bottle via one or more magnets.

Alternatively, or additionally, in another example, the sealing film may be a thermoplastic film.

According to another example, a cosmetic container may include, a bottle having a first open end and a second open end, defining a cavity therebetween. The first open end may include a neck portion, wherein the neck portion may include one or more outer threads. A sealing film may be adapted for placement at the second open end of the bottle, and a cap may be configured to engage with the second open end of the bottle, such that the cap fits over the sealing film thereby covering the sealing film and closing the second open end. A pump may be configured to engage with the one or more outer threads of the neck portion and may be used to dispense a product held within the cavity.

Alternatively, or additionally, in another example, the cap may engage with the second open end of the bottle via a snap-fit.

Alternatively, or additionally, in another example, the cap may engage with the second open end of the bottle via a thread fastening mechanism.

Alternatively, or additionally, in another example, the cap may engage with the second open end of the bottle via friction fit.

Alternatively, or additionally, in another example, the cap may engage with the second open end of the bottle via one or more magnets.

Alternatively, or additionally, in another example, the sealing film may be a foil film.

According to another example, a method of using a bottle to dispense a product, the bottle may include a first open end and a second open end, defining a cavity therebetween, a sealing film which may be adapted for placement at the second open end of the bottle, a cap which may be configured to engage with the second open end of the bottle, such that the cap fits over the sealing film thereby covering the sealing film and closing the second open end, and wherein the first open end may be adapted for dispensing a product held within the cavity of the bottle via a dispensing mechanism, the method may include; a user may dispense the product through the dispensing mechanism, the user may remove the cap and the sealing film, add product to the bottle from the second open end of the bottle, and the user may replace the cap.

Alternatively, or additionally, in another example, the dispensing mechanism may be a pump.

Alternatively, or additionally, in another example, the sealing film may be a foil film.

Alternatively, or additionally, in another example, the sealing film may be a thermoplastic film.

Alternatively, or additionally, in another example, the dispensing mechanism may be a disc top cap.

The above summary of some example embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a top perspective view of an illustrative cosmetic container;

FIG. 2 is a cross-section view of the illustrative container as in FIG. 1, taken at line 2-2;

FIG. 3 is an exploded view of the illustrative cosmetic container of FIG. 1;

FIG. 4 is a bottom perspective view of the illustrative container of FIG. 1;

FIG. 5 is a top perspective view of an illustrative bottle of the illustrative container;

FIG. 6 is a bottom perspective view of the illustrative bottle of the illustrative container;

FIG. 7 is a bottom perspective view of the illustrative bottle of the illustrative container including an illustrative sealing film;

FIG. 8 is a top perspective view of an illustrative cap;

FIGS. 9-11 are cross-section views of the illustrative cosmetic bottle of FIG. 5, taken at line 9-9, with a cap added, showing different closure mechanisms.

### DETAILED DESCRIPTION OF EXEMPLARY EMBODIMENTS

The following description should be read with reference to the drawings wherein the like reference numerals indicate like elements throughout the several views. The description and drawings show several embodiments which are meant to be illustrative in nature. The present description may use relative terms including, for example, left, right, top, bottom, front, back, upper, lower, up, and down, as well as others. It is to be understood that these terms are merely used for illustrative purposes and are not meant to be limiting in any manner.

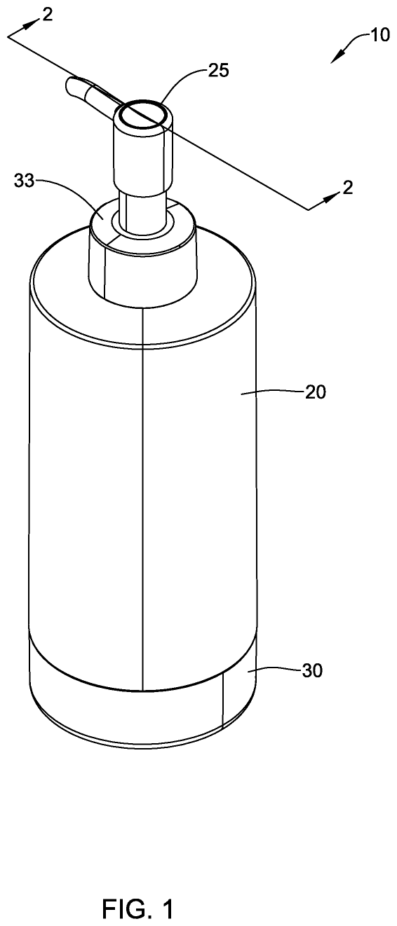

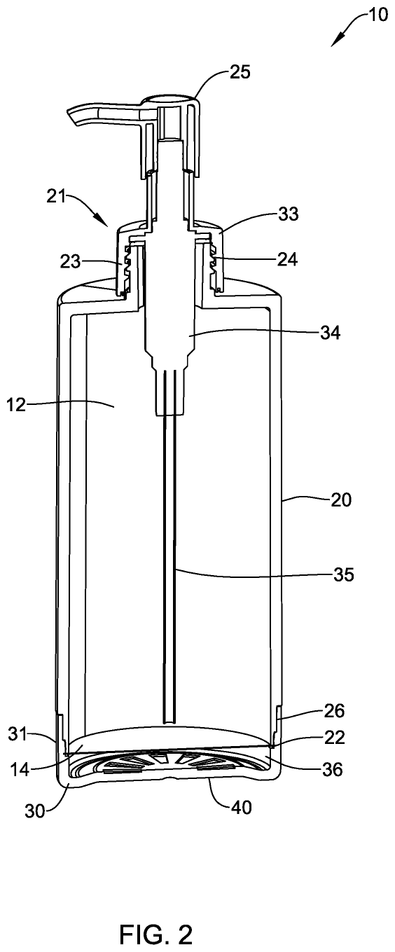

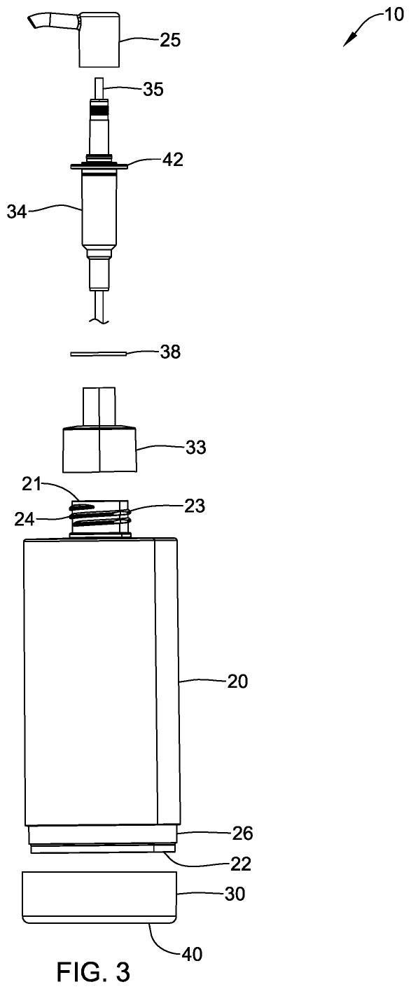

FIG. 1 is a top perspective view of an illustrative cosmetic container 10. As shown in FIG. 1, the cosmetic container 10 may include a bottle 20 and a cap 30. The bottle 20 may include a first open end 21 and a second open end 22, as shown in FIG. 2. The first open end 21 may be configured to engage with a dispensing mechanism, such as for example, a pump (e.g., pump 34 as shown in FIGS. 2 and 3) including a nozzle 25 and a collar 33. In some cases, the first open end 21 may be configured to engage with a cap, a disc top cap, a brush, a sponge, an applicator, or the like, but this may not be necessary. The cosmetic container 10 may include the bottle 20 having a cylindrical shape and the cap 30 having a circular shape, as shown in FIGS. 1-4. Alternatively, the cosmetic container 10 may have a shape that is square, rectangular, triangular, oval, or any other desired shape.

The cosmetic container 10 could be made as shown and described in U.S. patent application Ser. No. 62/756,949, titled Cosmetic Container with a Capped Seal, the disclosure of which is incorporated herein by reference, although other construction, such as molding, insert molding, removal processes and coupling together of multiple pieces by, for example and without limitation, adhesive, heat bonding, etc. may be used instead.

FIG. 2 is a cross-section view of the illustrative cosmetic container 10 as in FIG. 1, taken at line 2-2. As shown in FIG. 2, the cosmetic container 10 may include the bottle 20 having the first open end 21 and the second open end 22 defining a cavity 12 therebetween. The cavity 12 may be configured to receive and hold a cosmetic or medicinal product such as, liquids, creams, gels, and various makeup or skincare products such as foundation, concealer, lotion serum, petroleum products, sunscreen, moisturizer, etc. The first open end 21 may include a neck portion 23 which may include one or more outer threads 24. As discussed with reference to FIG. 1, the cosmetic container may include a pump 34 which may include the nozzle 25, the collar 33, and a tube 35. The neck portion 23 and the collar 33 may have a substantially round (e.g., cylindrical) shape in which the attachment of the collar 33 (e.g., the pump 34) to the bottle 20 may be provided by a thread fastening mechanism. For example, the collar 33 may include one or more inner threads 37, which may be configured to engage with the one or more outer threads 24 of the neck portion 23, thereby attaching the pump 34 to the bottle 20. However, it is contemplated that the collar 33 and the neck portion 23 may have an alternative shape (e.g., square, rectangular, oval, triangular, or any other shape desired) and may be attached by a magnetic fastening mechanism, a snap fastening mechanism (e.g., a snap fit) or a clamp fastening system. It may be further contemplated that an outer profile of the collar 33 and the bottle 20 have one shape, such as square, and inner pieces have a second, substantially round shape, wherein closure may be provided by a thread, snap, or other suitable fastening mechanism.

The pump 34 may be used to dispense the product held within the cavity 12 of the bottle 20. In some cases, the pump 34 may be omitted and the first open end 21 may be configured to engage with a cap, a disc top cap, a brush, a sponge, an applicator, or the like. In some cases, a c-ring 32 may be configured for placement around the pump 34 below the nozzle 25 so as to prevent the nozzle 25 from being depressed. As such, the c-ring 32 may prevent inadvertent dispensing of the product within the cavity 12 of the bottle 20.

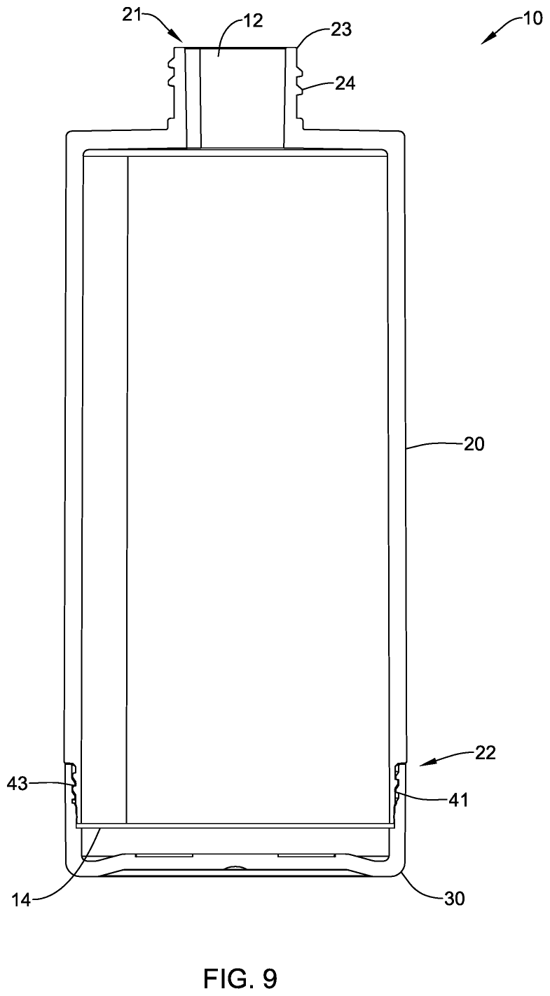

The cosmetic container 10 may include a sealing film 14 adapted for placement at the second open end 22 of the bottle 20. The sealing film 14 may be a foil film, a thermoplastic film, or the like. The sealing film 14 may be secured to the second open end 22 of the bottle 20 using heat, adhesive, or any other suitable method of attachment. The cap 30 may be configured to engage with the second open end 22 of the bottle 20 such that the cap 30 fits over the sealing film 14, thereby covering the sealing film 14 and closing the second open end 22 of the bottle 20. As shown in FIG. 2, the cap 30 may include a ridge 31 on an inner side 36 of the cap 30, which may be configured to engage with a groove 26 at the second open end 22 of the bottle 20 via friction fit. In some examples, the cap 30 may engage with the second open end 22 of the bottle 20 via a snap-fit, a thread-fastening mechanism, via one or more magnets, or any other suitable method of attachment (as shown further in FIGS. 9-11). The cap 30 may further include a bottom 40 which may be formed such that the cosmetic container 10 may stand upright when the bottle 20 and the cap 30 are assembled.

In use, a user may remove the c-ring 32 from the pump 34 and depress the nozzle 25 of the pump 34. Releasing the nozzle 25 (e.g., removing depression force) may allow the product within the cavity 12 of the bottle 20 to draw up within the tube 35 of the pump 34. Depression and release of the nozzle 25 may allow a user to draw the product out of the bottle 20 for application. Upon depletion of the product (e.g., when a user can no longer draw product through the nozzle 25 of the pump 34), a user may remove the cap 30 from the second open end 22 of the bottle 20. The user may then remove the sealing film 14 from the second open end 22 of the bottle 20. In some cases, the sealing film 14 may include a tab which a user may be able to grab and pull the sealing film 14 away from the second open end 22 of the bottle 20. The user may then have access to additional product in the bottle 20 that may not have been reached by the tube 35 of the pump 34. Thus, the user may use the entirety of the product contained within the cosmetic container 10. In some cases, the user may refill the cosmetic container 10 once the product is depleted by adding product to the bottle 20 from the second open end 22 of the bottle 20. The user may then replace the cap 30, thereby sealing the second open end 22 of the bottle 20.

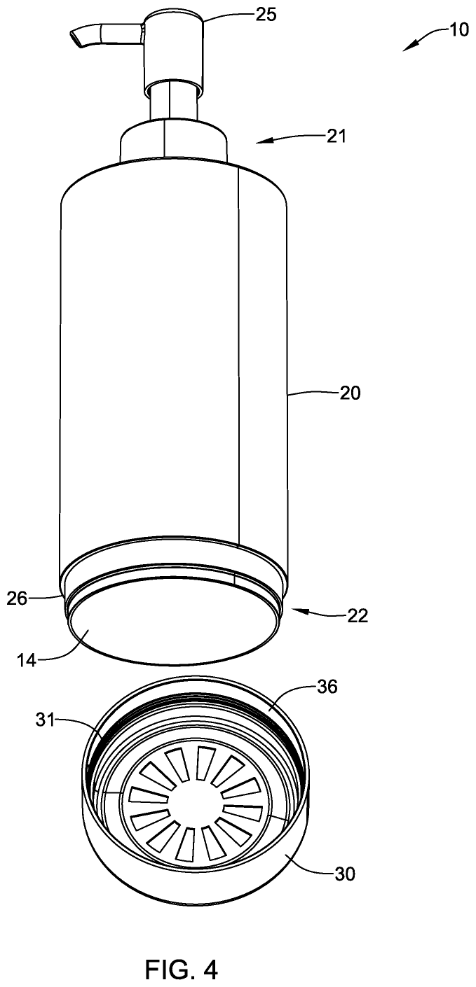

FIG. 3 is an exploded view of the illustrative cosmetic container 10 of FIG. 1. As shown in FIG. 3, the cosmetic container 10 may include the bottle 20 having the first open end 21 and the second open end 22, defining the cavity 12 therebetween. The first open end 21 may include the neck portion 23, which may include the one or more outer threads 24. The second open end 22 of the bottle 20 may include the groove 26. The cap 30 may include the ridge 31 on the inner side 36 (as shown in FIG. 4) of the cap 30 which may be configured to engage with the groove 26 at the second open end 22 of the bottle 20 via friction fit. The cap 30 may further include the bottom 40, which may be configured such that the cosmetic container 10 may stand upright when the bottle 20 and cap 30 are assembled together.

The cosmetic container 10 may include the pump 34 which may be configured to fit within the neck portion 23 of the bottle 20. The pump 34 may include a rim 42 which may be configured to engage with the neck portion 23 and serve as a stop for the pump 34. In this manner, when the pump 34 is placed within the neck portion 23 of the bottle 20, the rim 42 abuts the neck portion 23 of the bottle 20 thereby preventing further advancement of the pump 34 into the cavity 12 of the bottle 20.

In some cases, as shown in FIG. 3, the tube 35 may be adapted to fit within the pump 34 via friction fit. In some cases, it may be contemplated that the tube 35 and the pump 34 may be formed as one monolithic piece. The pump 34 may be placed within the neck portion 23 of the bottle 20, and the collar 33 may be configured to fit over the pump 34.

The inner threads 37 of the collar 33 may be configured to engage with the outer threads 24 of the neck portion 23, thereby securing the pump 34 to the bottle 20. In some cases, a gasket 38 may be configured for placement under the rim 42 of the pump 34 to provide a seal between the pump 34 and the neck portion 23 of the bottle 20 when the cosmetic container 10 is assembled. In some cases, the gasket 38 may be omitted, and an adequate seal may be had by the attachment of the collar 33 to the neck portion 23 and subsequent attachment of the pump 34 to the neck portion 23 of the bottle 20. The nozzle 25 may be configured to engage with the tube 35 of the pump 34 via friction fit, snap-fit, or any other suitable method of attachment. As discussed with reference to FIG. 2, the pump 34, the collar 33, the nozzle 25, and the tube 35 may be omitted and the first open end 21 may be configured to engage with a cap, a disc top cap, a brush, a sponge, an applicator, or the like.

FIG. 4 is a bottom perspective view of the illustrative cosmetic container 10 of FIG. 1, with the cap 30 removed. As shown in FIG. 4, the sealing film 14 may be adapted for placement at the second open end 22 of the bottle 20. The sealing film 14 may be a foil film, a thermoplastic film, or the like. The sealing film 14 may be secured to the second open end 22 of the bottle 20 using heat, adhesive, or any other suitable method of attachment. Although not shown, it may be contemplated that the sealing film 14 may include a tab to aid in removal of the sealing film 14, but this is not necessary. As shown in FIG. 4, the cap 30 may include a ridge 31 on the inner side 36 of the cap 30. The ridge 31 may be configured to engage with the groove 26 at the second open end 22 of the bottle 20. Thus, the cap 30 may be placed over the sealing film 14, and the groove 26 and the ridge 31 engage via friction fit so as to close the second open end 22 of the bottle 20.

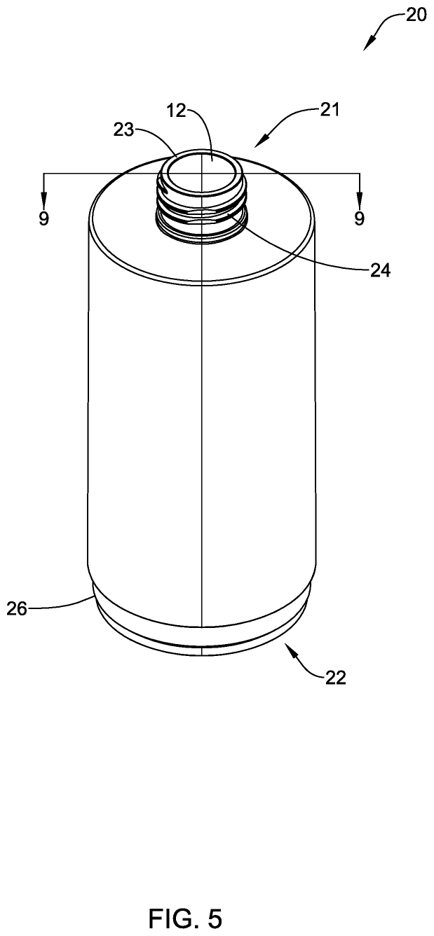

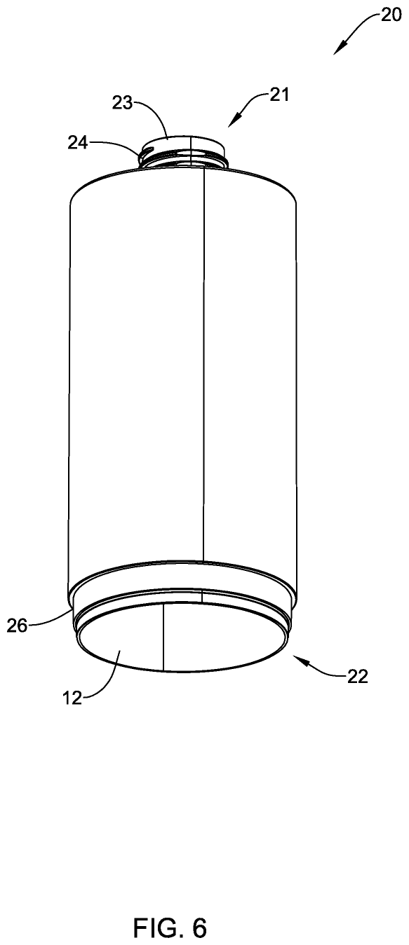

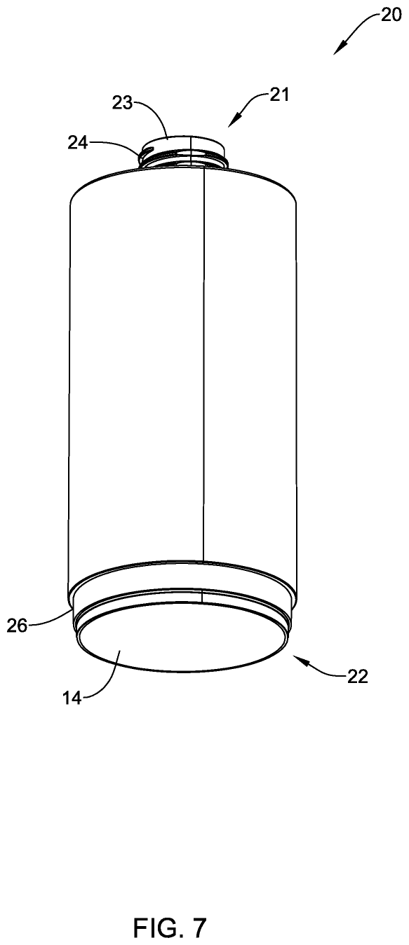

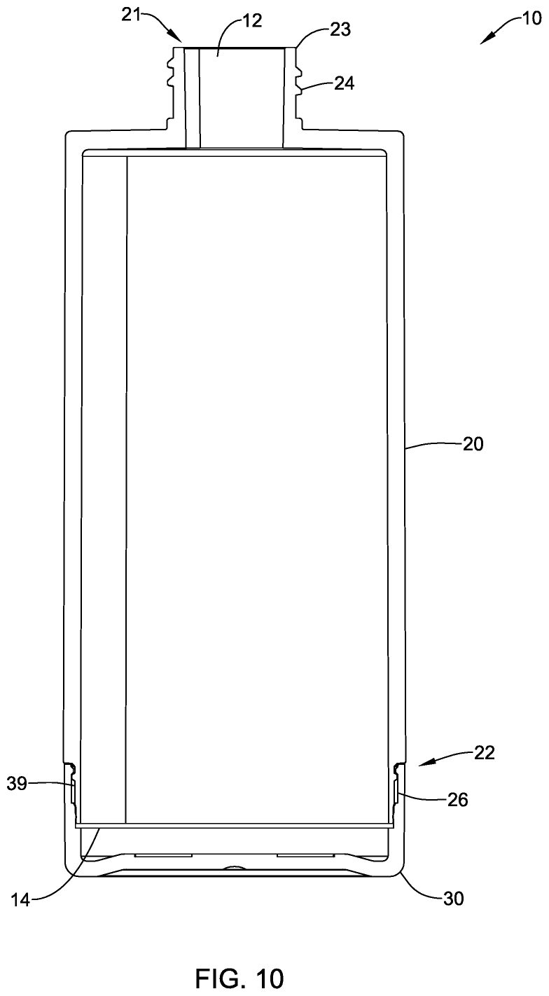

FIGS. 5-7 are perspective views of the illustrative bottle 20 of the illustrative cosmetic container 10. FIG. 5 is a top perspective view of the bottle 20 of the cosmetic container 10, and FIG. 6 is a bottom perspective view of the bottle 20 of the cosmetic container 10. As shown in FIGS. 5 and 6, the bottle 20 may include the first open end 21 and the second open end 22 defining the cavity 12 therebetween. The cavity 12 may be configured to receive and hold a cosmetic or medicinal product such as, liquids, creams, gels, and various makeup or skincare products such as foundation, concealer, lotion serum, petroleum products, sunscreen, moisturizer, etc. The first open end 21 may include the neck portion 23 which may include one or more outer threads 24. The neck portion 23 of the first open end 21 of the bottle 20 may be configured to engage with a dispensing mechanism such as, for example, a pump (e.g., pump 34), a cap, a disc top cap, a brush, a sponge, an applicator, or the like. In some cases, the one or more outer threads 24 may be omitted and the dispensing mechanism may be attached to the neck portion 23 via snap-fit, friction fit, heat-welding, injection molding, adhesion, or any other suitable method of attachment. The second open end 22 of the bottle 20 may include the groove 26. The groove 26 may be configured to engage with the ridge 31 of the cap 30. In some cases, the groove 26 may be configured to engage with a tab (e.g., tab 39 shown in FIG. 10). In some cases, as shown in FIG. 7, the second open end 22 of the bottle 20 may include the sealing film 14. The sealing film 14 may be a foil film, a thermoplastic film, or the like. The sealing film 14 may be secured to the second open end 22 of the bottle 20 using heat, adhesive, or any other suitable method of attachment. The sealing film 14 may be removed by a user such that the user may access the entirety of the product held within the cavity 12 of the bottle 20. Alternatively, the sealing film 14 may be removed by a user to refill the cavity 12 of the bottle 20 with a desired product.

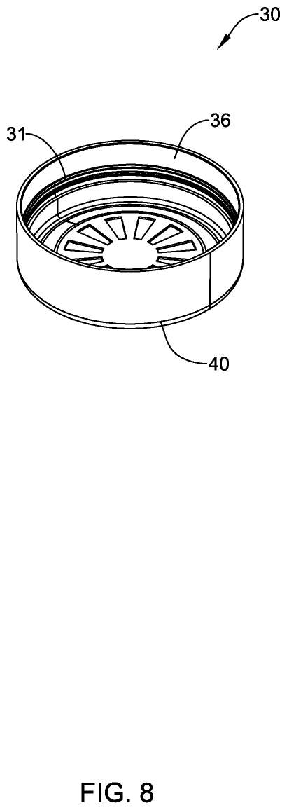

FIG. 8 is a top perspective view of the illustrative cap 30 of the illustrative cosmetic container 10. The cap 30 may include the ridge 31 on the inner side 36 of the cap 30 which may be configured to engage with the groove 26 at the second open end 22 of the bottle 20 via friction fit. The cap 30 may further include the bottom 40, which may be configured such that the cosmetic container 10 may stand upright when the bottle 20 and cap 30 are assembled together.

FIGS. 9-11 are cross-section views of the illustrative cosmetic bottle 20 of FIG. 5, taken at line 9-9, including the cap 30, illustrating various embodiments of the cosmetic container 10. In one example embodiment, as shown in FIG. 9, the cosmetic container 10 may be similar to the cosmetic container 10 in FIGS. 1-4, wherein the cosmetic container 10 in FIG. 9 may include the bottle 20 having the first open end 21 and the second open end 22 defining the cavity 12 therebetween. The cosmetic container 10 in FIG. 9 may differ from the cosmetic container 10 in FIGS. 1-4, however, in that the second open end 22 may include one or more outer threads 41 which may be configured to engage with one or more inner threads 43 of the cap 30. In this manner, the cap 30 may be attached to the bottle 20 via threaded coupling. While the bottle 20 and the cap 30 are illustrated as having a substantially round (e.g., cylindrical) shape, it may be contemplated that the bottle 20 and the cap 30 have one shape, such as square, and inner pieces have a second, substantially round shape, wherein closure may be provided by the thread fastening mechanism.

In another example embodiment, as shown in FIG. 10, the cosmetic container 10 may be similar to the cosmetic container 10 in FIGS. 1-4, wherein the cosmetic container 10 in FIG. 9 may include the bottle 20 having the first open end 21 and the second open end 22 defining the cavity 12 therebetween. The cosmetic container 10 in FIG. 10 may differ from the cosmetic container 10 in FIGS. 1-4, however, in that the second open end 22 may include the groove 26 which may be configured to engage with a tab 39 of the cap 30. In this manner, the cap 30 may be attached to the bottle 20 via snap-fit closure. While the bottle 20 and the cap 30 are illustrated as having a substantially round (e.g., cylindrical) shape, it may be contemplated that the bottle 20 and the cap 30 have an alternative shape (e.g., square, rectangular, oval, triangular, or any other shape desired) and thus, may be sealed by a snap fastening mechanism (e.g., snap-fit).

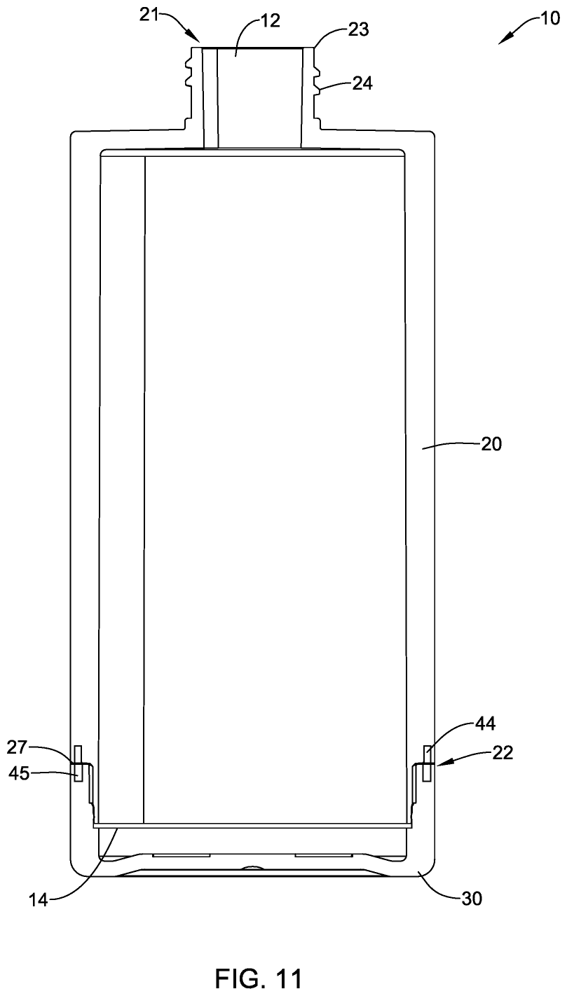

In another example embodiment, as shown in FIG. 11, the cosmetic container 10 may be similar to the cosmetic container 10 in FIGS. 1-4, wherein the cosmetic container 10 in FIG. 9 may include the bottle 20 having the first open end 21 and the second open end 22 defining the cavity 12 therebetween. The cosmetic container 10 in FIG. 11 may differ from the cosmetic container 10 in FIGS. 1-4, however, in that the second open end 22 may include a slot 44 which may include a first magnet 27. The first magnet 27 may be configured to reside within the slot 44, however, it may be contemplated that the first magnet 27 may be disposed on, embedded in, attached to, or otherwise a part of the bottle 20. The first magnet 27 may be configured to engage with a second magnet 45 which may be placed within the cap 30. The second magnet 45 may be disposed on, embedded in, attached to, or otherwise a part of the cap 30. An attractive force between the first magnet 27 and the second magnet 45 may hold the cap 30 onto the bottle 20, thereby closing the cosmetic container 10. While the cosmetic container 10 is illustrated as including the first magnet 27 and the second magnet 45, the cosmetic container 10 may include any number of magnets as desired, such as, but not limited to, one magnet, four magnets, six magnets, eight magnets, etc.

In some embodiments, the cosmetic container 10 and/or the various components thereof may be made from a rigid material (e.g., acrylonitrile butadiene styrene, thermoplastics, other polymers, glass, metal, alloy, wood, and the like). Other embodiments may, however, include containers 10 made from a flexible or semi-rigid material, such as plastic. In some embodiments, the bottle 20 may comprise a transparent or translucent material so that the cosmetic product within may be externally viewed and/or for decorative purposes (e.g., showing decoration).

For the following defined terms, these definitions shall be applied, unless a different definition is given in the claims or elsewhere in this specification. In this document, the terms “a” or “an” are used, as is common in patent documents, to include one or more than one, independent of any other instances or usages of “at least one” or “one or more” unless the content clearly dictates otherwise. Moreover, in the following claims, the terms “first,” “second,” and “third,” etc. are used merely as labels, and are not intended to impose numerical requirements on their objects. As used in the above description and the appended claims, the term “or” is generally employed in its sense including “and/or” unless the content clearly dictates otherwise.

The above description is intended to be illustrative, and not restrictive. The above described embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. For example, the above examples (or one or more aspects thereof) may be used in combination with each other. Other embodiments can be used, such as by one of ordinary skill in the art upon reviewing the above description.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that all the appended claims be construed to cover all such equivalent variations a fall within the true spirit and scope of the invention.

What is claimed is:

1. A cosmetic container, comprising:
a bottle having a first open end and a second open end, defining a cavity therebetween;
a sealing film adapted for placement at the second open end of the bottle;
a cap configured to engage with the second open end of the bottle, wherein the cap fits over the sealing film thereby covering the sealing film and closing the second open end; and
wherein the first open end is adapted for dispensing a product held within the cavity of the bottle.

2. The cosmetic container of claim 1, wherein the sealing film is a foil film.

3. The cosmetic container of claim 1, wherein the first open end includes a neck portion, wherein the neck portion includes one or more outer threads.

4. The cosmetic container of claim 3, further comprising a pump configured to engage with the one or more outer threads of the neck portion, the pump being used to dispense the product held within the cavity.

5. The cosmetic container of claim 1, wherein the cap engages with the second open end of the bottle via a snap-fit.

6. The cosmetic container of claim 1, wherein the cap engages with the second open end of the bottle via a thread fastening mechanism.

7. The cosmetic container of claim 1, wherein the cap engages with the second open end of the bottle via friction fit.

8. The cosmetic container of claim 1, wherein the cap engages with the second open end of the bottle via one or more magnets.

9. The cosmetic container of claim 1, wherein the sealing film is a thermoplastic film.

10. A cosmetic container, comprising:
a bottle having a first open end and a second open end, defining a cavity therebetween, the first open end includes a neck portion, wherein the neck portion includes one or more outer threads;
a sealing film adapted for placement at the second open end of the bottle;
a cap configured to engage with the second open end of the bottle, wherein the cap fits over the sealing film thereby covering the sealing film and closing the second open end; and
a pump configured to engage with the one or more outer threads of the neck portion and is used to dispense a product held within the cavity.

11. The cosmetic container of claim 10, wherein the cap engages with the second open end of the bottle via a snap-fit.

12. The cosmetic container of claim 10, wherein the cap engages with the second open end of the bottle via a thread fastening mechanism.

13. The cosmetic container of claim 10, wherein the cap engages with the second open end of the bottle via friction fit.

14. The cosmetic container of claim 10, wherein the cap engages with the second open end of the bottle via one or more magnets.

15. The cosmetic container of claim 10, wherein the sealing film is a foil film.

16. A method of using a bottle to dispense a product, the bottle comprising a first open end and a second open end, defining a cavity therebetween, a sealing film adapted for placement at the second open end of the bottle, a cap configured to engage with the second open end of the bottle, wherein the cap fits over the sealing film thereby covering the sealing film and closing the second open end, and wherein the first open end is adapted for dispensing a product held within the cavity of the bottle via a dispensing mechanism, the method comprising:
a user dispensing the product through the dispensing mechanism;
the user removing the cap and the sealing film;
the user adding product to the bottle from the second open end of the bottle; and
the user replacing the cap.

17. The method of claim 16, wherein the dispensing mechanism is a pump.

18. The method of claim 16, wherein the sealing film is a foil film.

19. The method of claim 16, wherein the sealing film is a thermoplastic film.

20. The method of claim 16, wherein the dispensing mechanism is a disc top cap.
